(19) United States
(12) Patent Application Publication
(10) Pub. No.: US 2006/0187849 A1
(43) Pub. Date: Aug. 24, 2006

(54) Interpreter engine

(76) Inventor: Mohamed Hamedi, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/064,140

(22) Filed: Feb. 22, 2005

(51) Int. Cl. H04L 12/26

(52) U.S. Cl. 370/252

(57) ABSTRACT

In one embodiment, an apparatus for permitting interpretation of a protocol in a network, includes: a network device including an interpreter engine configured to receive a script file and interpret a protocol based upon the script file; and a processor configured to execute the interpreter engine. In another embodiment, a method for permitting interpretation of a protocol in a network, includes: receiving a script file; and interpreting a protocol based upon the script file.

### TECHNICAL FIELD

Embodiments of the invention relate generally to communication networks, and more particularly to an interpreter engine in a network device.

### BACKGROUND

Network devices can communicate with each other in a network by use of protocols such as a device discovery mechanism. Typically, a network device in a network will require the device discovery mechanism, so that the network device can identify other devices in the network and communicate with the other devices in the network. The device discovery mechanism permits the network device to, for example, learn about the device types among neighboring devices, the capabilities of the neighboring devices, and the addresses of the neighboring devices in the network. The device discovery mechanism also permits the network device to advertise its addresses and its capabilities.

One current device discovery mechanism is the CDP (Cisco Discovery Protocol) protocol from Cisco Systems, Inc., San Jose, Calif. The CDP protocol is described further in, for example, the following publication which is hereby incorporated herein by reference: CONFIGURING CISCO DISCOVERY PROTOCOL: CISCO IOS CONFIGURATION FUNDAMENTALS CONFIGURATION GUIDE <http://www.cisco.com/univercd/cc/td/doc/product/software/i os121/121cgcr/fun_c/fcprt3/fcd301c.pdf>. Other discovery mechanisms include, for example, the Ironview® Network Manager from Foundry Networks, Inc., Alviso, Calif., and LLDP (Link Layer Discovery Protocol) which is an open standard for device discovery and physical topology discovery.

However, a network device (e.g., a switch or other device) that will use a discovery protocol (e.g., CDP) will require the user of the network device to program in code the various specifications of the discovery protocol. This code is programmed into the network device and permits the network device to comply with the discovery protocol. For example, the code will identify the following information: (1) information gathered by the network device when using the discovery protocol; (2) information sent by the network device in response to a request, when using the discovery protocol; (3) other information that is required in order for the network device to use the discovery protocol.

However, the user of this network device is required to license the use of the CDP protocol (or other particular discovery protocols or other relevant protocols) and to program the various specifications of the CDP protocol into the network device. This required code programming leads to additional expenses and a relatively longer time to market the devices due to the added programming time for supporting the CDP protocol.

Additionally, in order to use an upgraded version of a discovery protocol (e.g., a future upgraded version of the CDP protocol), the user of the network device is also typically required to license the upgraded discovery protocol version and to program the various specifications of the upgraded discovery protocol version into the network device. In other words, the current discovery protocols are in firmware, and the only way to update the discovery protocol is by upgrading the firmware on the network device. Therefore, the use of the CDP protocol (and/or other protocols) in a network device leads to expenses and inconvenience for users, and downtime for the network.

Therefore, the current technology is limited in its capabilities and suffers from at least the above constraints and deficiencies.

### SUMMARY OF EMBODIMENTS OF THE INVENTION

In one embodiment of the invention, an apparatus for permitting interpretation of a protocol in a network, includes: a network device including an interpreter engine configured to receive a script file and interpret a protocol based upon the script file; and a processor configured to execute the interpreter engine.

In another embodiment of the invention, a method for permitting interpretation of a protocol in a network, includes: receiving a script file; and interpreting a protocol based upon the script file.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a network system in accordance with an embodiment of the invention.

FIG. 2 is a block diagram that represents a script file used in accordance with an embodiment of the invention.

FIG. 3 is a method in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

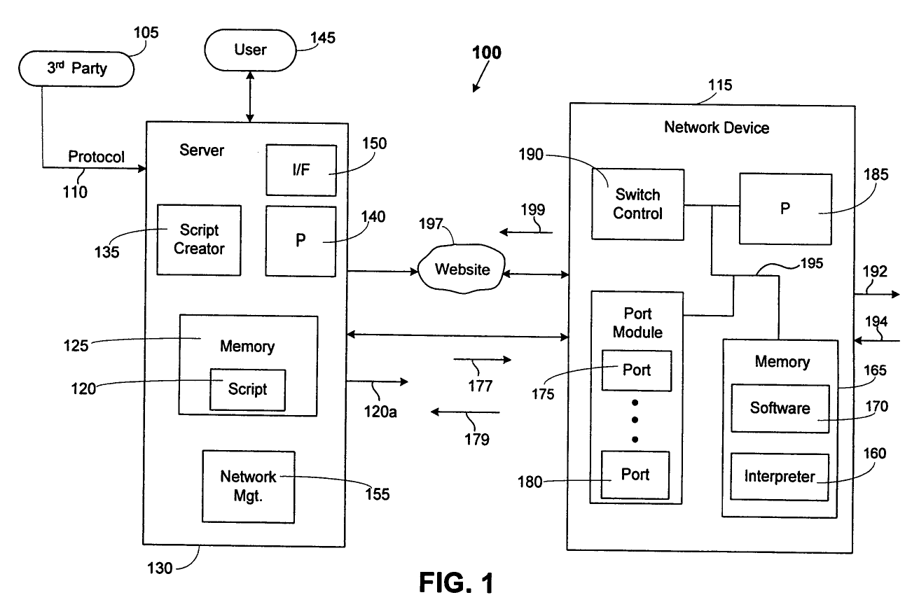

FIG. 1 is a block diagram of a network 100, in accordance with an embodiment of the invention. Typically, a third-party 105 (e.g., a vendor) provides a protocol 110 which is a mechanism or language that is used for communication between devices in the network 100. For example, the protocol 110 is a discovery protocol (e.g., CDP), although the protocol 110 is not necessarily a discovery protocol and may be another type of protocol used in network communications. As an example, the protocol 110 will permit a network device 115 to provide a particular response to a query from another device in the network 100, and the protocol 110 will also dictate the method for response or behavior by the network device 115. The network device 115 can be, for example, a network switch, a router, or another suitable network device.

Particular examples of the protocol 110 include the device discovery protocols such as, for example, the CDP discovery protocol, Ironview® Network Manager protocol, the LLDP protocol, or another type of network protocol such as a voice-over-Internet-Protocol (voice-over-IP), a wireless communication protocol, or another suitable type of network protocol.

In an embodiment of the invention, the characteristics and parameters of the protocol 110 are contained in or indicated in a script file 120, as discussed in additional details below. Typically, the script file 120 is stored in a memory 125 of a server 130. As known to those skilled in the art, in computer programming, a script is a program or sequence of instructions that is interpreted or carried out by another program rather than by the computer processor. In general, script languages are easier and faster to code in than the more structured and compiled languages such as C and C++. However, a script may take longer to run than a compiled program since each instruction is being handled by another program first (requiring additional instructions) rather than directly by the basic instruction processor.

The script file 120 is typically an XML (Extensible Markup Language) file that includes a list of parameters or characteristics of a particular network protocol 110. As known to those skilled in the art, XML is a flexible way to create common information formats and share both the format and the data on the Internet, Intranets, and elsewhere.

A script creator program 135 is used to create a script file 120. The script creator program 135 is executed by the server processor 140. The characteristics and parameters of the network protocol 110 are placed by the script creator program 135 into a script file 120, when a user 145 inputs these protocol characteristics and parameters into the script creator program 135 via a user interface 150. For example, the user 145 can fill in fields provided by the user interface 150, where the fields contain parameters or description of the particular network protocol 110. These parameters or description include, for example, the following: the port that the network device 115 will listen to; name and type of the network protocol 110; input signals that are processed in accordance with the network protocol 110; output signals that are generated in accordance with the network protocol 110; packet description of a packet used by the network protocol 110; actions in response to particular events; and/or other rule sets. The script creator program 135 can be written in, for example, JAVA, C++, VISUAL BASIC, or other suitable programming languages, and can be programmed by use of standard code programming techniques.

Typically, the format of the script file 120 is required to function with the format of an interpreter engine 160 in a memory 165 of the network device 115. Therefore, the script file 120 and the interpreter engine 160 are programmed so that the interpreter engine 160 can understand and read the script file 120. The interpreter engine 160 essentially operates as an adaptive embedded discovery engine, as discussed in further detail below.

The interpreter engine 160 is typically in the same programming language as the software 170 that is embedded in the network device 115. For example, the interpreter engine 160 is programmed in a suitable programming language such as C, and can be programmed by use of standard code programming techniques.

The interpreter engine 160 will parse and interpret a script file 120 that has been received by the network device 115 from the server 130. By parsing and interpreting the script file 120, the interpreter engine 160 executes the script file 120 so that the network device 115 can behave in accordance with the requirements of the network protocol 110. Therefore, the interpreter engine 160 avoids the previous requirement of embedding a firmware in network devices so that the network devices can behave in accordance with the requirements of a protocol that is implemented by the firmware.

In response to a policy (i.e., rule sets) in the script file 120, the interpreter engine 160 will perform an action based upon the policy in the script file 120 or perform a standard device operation for the network device 115. Therefore, the policy (rule sets) in the script file 120 will dictate the response and behavior of the network device 115 in accordance with the network protocol 110 and will indicate how the network device 115 can perform the required behavior or response in accordance with the protocol 110. For example, if the policy in the script file 120 requires the network device 115 to listen to port 175 (in port module 180 in network device 115) and perform a particular behavior (or response) based upon a particular packet 177 received on port 175, then the network device 115 can perform the particular behavior or response. As another example, the policy in the script file 120 will format a packet 179 in accordance with the protocol 110.

The processor 185 in the network device 115 executes the interpreter engine 160 and can perform an action to configure the network device 115 in accordance with the rule sets or policy in the script file 120. If the network device 115 is a network switch, then a switch control 190 can also be configured by the processor 185 to perform an action in accordance with the rule sets or policy in the script file 120. Typically, a switch's processor performs overall configuration and control of the operation of a switch. The processor 185 operates in cooperation with the switch control 190. The switch control 190 is typically an application specific integrated circuit (ASIC) designed to assist the processor 185 in performing packet switching at high speeds as required by modern networks. Typically, the switch control 190 includes an inbound buffer and an outbound buffer for exchanged data over a switch bus 195 and port module 180.

The port module 180 has the multiple network ports of a switch. Each of the ports typically includes an inbound buffer and an outbound buffer. The inbound buffer is configured to receive packets from the network medium connected to the port module 180 and the outbound buffer is configured to queue data associated with the transmission of packets to be sent to the network medium. The port module 180 includes circuits (not specifically shown in FIG. 1) to connect its ports to the switch bus 195 which is connected to the switch control 190.

The memory 165 can hold received packets for processing by the processor 185.

Other standard components that permit the network device 115 to perform, for example, switching operations or other network operations, are not shown in FIG. 1 for purposes of focusing on the operations of embodiments of the invention.

As one option, the network device 115 can access a website 197 that publishes the script file 120 by sending a request 199 from the network device 115. The website 197 is served by, for example, the server 130, although another server can serve the website 197. Therefore, the user of the network device 115 can download the script file 120 from the website 197 to the network device 115. The script file 120 is then stored in the memory 165 of the network device 115 and parsed and executed by the interpreter engine 160, so that the network device 115 can function in accordance with the requirements of the network protocol 110.

The script file 120 can be loaded in the network device 115 in a similar manner as a new firmware image is pushed into a network device. Therefore, the protocol 110 associated with the script file 120 is effectively pushed to the network device 115 with minimum impact on the network device 115 and on the network 100. The flexible solution provided by an embodiment of the invention is not provided by conventional firmware updates mechanisms.

As another option, a network management application 155 can push (transmit) the script file 120 to the network device 115. The network management application 155 would push the script file 120 in packet format 120a that is transmitted to the network device 115.

As another option, the network management application 155 can also poll the network device 115 to determine if the network device 115 has the script file 120, and transmit the script file 120 to the network device 115 in packet format 120a, if the network device 115 does not have the script file 120. As an example, the network management application 155 is programmed in a suitable programming language such as, for example, C, and can be programmed by use of standard code programming techniques.

The network management application 155 can examine the network 100 and determine the particular network devices that will need the script file 120 (if the network device does not have the script file), or determine the particular network devices that will need an updated version of the script file 120 (if the script file has been updated/upgraded on the server 130). This process of discovering the network 100 for script file 120 in network devices 115 may be performed by the network management application 155 by use of known discovery methods that are performed in some current network discovery application software. One example of a current discovery method is_of the type that is used by the product known as PROCURVE MANAGER™ which is commercially available from HEWLETT-PACKARD COMPANY, Palo Alto, Calif. The network management application 155 will then push the script file 120 to the network device(s) 115 that will require the script file 120 (or an updated version of the script file 120). This method of pushing the script file 120 to network devices 115 is particularly useful if, for example, the network 100 has a multiple number of network devices 115.

As another option, the script file packet 120a can be encrypted by the script creator program 135 by use of conventional encryption techniques, and the interpreter engine 160 has the capability to decrypt the script file packet 120a in accordance with the selected encryption algorithm. Standard encryption and decryption methods may be used for encrypting and decrypting the script file packet 120a. This optional feature provides added network security.

As another option, the interpreter engine 160 has the capability to push the script file 120 to another interpreter engine in another network device. The interpreter engine 160 can announce to the other interpreter engine (and/or other interpreter engines) that it has a new script file 120 or a script file 120 that has been updated/upgraded, and can then send the script file 120 via a broadcast packet 192 to the other interpreter engines in other network devices. Standard packet broadcast techniques may be used to broadcast the broadcast packet 192 to other network devices.

Additionally or alternatively, the other interpreter engines (in the other network devices) can poll the interpreter engine 160 by use of a polling packet 194, so that the other interpreter engines can determine if the interpreter engine 160 has a new script file 120 or a script file 120 that has been updated/upgraded. This process of determining if the script file 120 is new or has been updated/upgraded may be performed by use of known discovery methods that are performed in some current network discovery application software.

The software, applications, or engines shown the figures can be implemented in hardware, software, firmware, or a combination of hardware, software, and firmware. The various components shown in FIG. 1, such as, for example, the processor 185, memory 160, switch control 190, port module 180, and switch bus 195 in the network device 115 can be implemented in hardware or other suitable known component structures.

An advantage of an embodiment of the invention is that firmware and associated royalties will not be required for the user of the network device 115, for a particular network protocol 110. As known to those skilled in the art, firmware is programming code that is inserted into programmable read-only memory (programmable ROM) or is stored in a ROM, thus becoming a permanent part of a computing device. When ready, firmware can be distributed like other software and, using a user interface, installed in the programmable read-only memory by a user.

The interpreter engine 160 is adaptive, and as a result, any modifications or updates/upgrades to a particular network protocol 110 can be received by modifying or re-writing the script file 120 associated with the network protocol 110. In other words, a list of instructions or rule sets in the script file 120 is modified via the user interface 150 (FIG. 1) to reflect the modifications or updates/upgrades in the particular network protocol 110. This adaptive feature of an embodiment of the invention results in a quicker time-to-market for the network device 115, since the network device 115 will not require re-booting (and associated downtime) because the previously-required firmware update is now not required for the network device 115. The re-booting procedure for a network device 115 can be expensive and inconvenient, particularly if a network 100 will require the re-boot of a large number of network devices 115 due to a protocol upgrade/update.

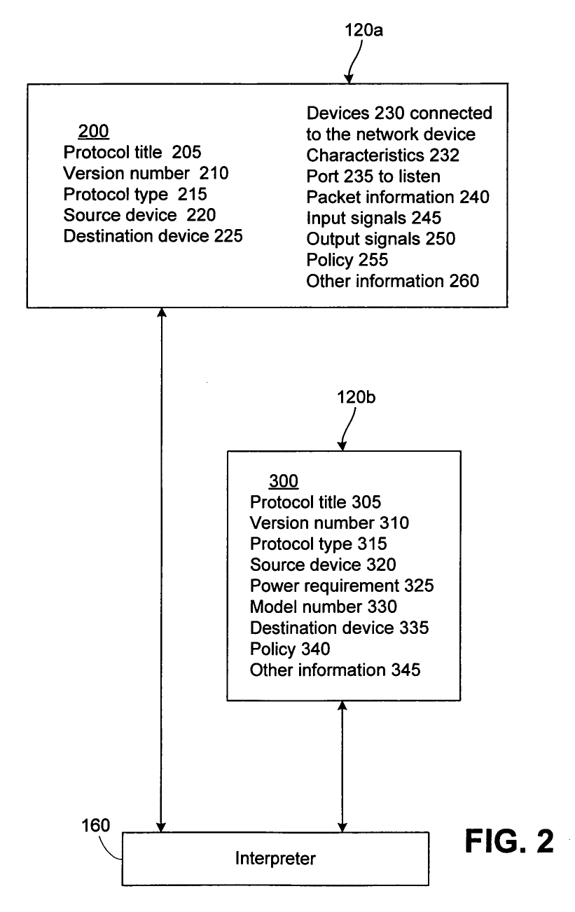

FIG. 2 is a block diagram that represents script files 120 (e.g., script files 120a and 120b) that is used in accordance with an embodiment of the invention. The parameters (or characteristics) 200 of a protocol 110 in a script file 120a include, for example, the following information: title (name) 205 of protocol (e.g., CDP); protocol version number 210 (e.g., version 2); protocol type 215 (e.g., discovery protocol or voice-over-internet-protocol or wireless communication protocol); source device 220; destination device 225; list 230 of devices connected to the network device 215; characteristics 232 of devices connected to the network device 215; port 235 (in the network device 115) to listen to (e.g., port 175 in the example of FIG. 1); information 240 in packets transmitted by the protocol 110; input signals 245; output signals 250; policy (rule sets) 255 in response to events defined by the protocol 110; other information 260 that is used by the network device 115 in order to function in accordance with the requirements of the protocol 110. These parameters 200 for a network protocol are known to those skilled in the art.

As another example, if the protocol 110 is a voice-over-internet-protocol, then the protocol 110 will have, for example, the following parameters (characteristics) 300 in a script file 120b: title (name) 305 of protocol; protocol version number 310 (e.g., version 2); protocol type 315; source device 320; power requirement 325; model number 330; destination device 335; policy (rule sets) 340 in response to events defined by the protocol 110; other information 345 that is used by the network device 115 in order to function in accordance with the requirements of the protocol 110. These parameters 300 for a voice-over-internet protocol are known to those skilled in the art.

The interpreter engine 160 will parse the script file 120 and read each line in the script file 120, in order to determine the parameters and characteristics 200 of the network protocol 110. Based upon the parameters and characteristics 200, the interpreter 160 permits the network device 115 to function and behave in accordance with the requirements of the protocol 110. Therefore, the script file 120 permits the network device 115 to effectively function as if the firmware image for the protocol 110 has been loaded into the network device 115.

The script file contents 200 can be changed or modified if the associated protocol is upgraded, as previously discussed above. The interpreter engine 160 can execute the modified script file so that the network device can function in accordance with the upgraded protocol. Therefore, the interpreter engine 160 permits the network device 115 to be adaptive by being able to accept and function in accordance with different protocols and upgrades in the protocols without new firmware.

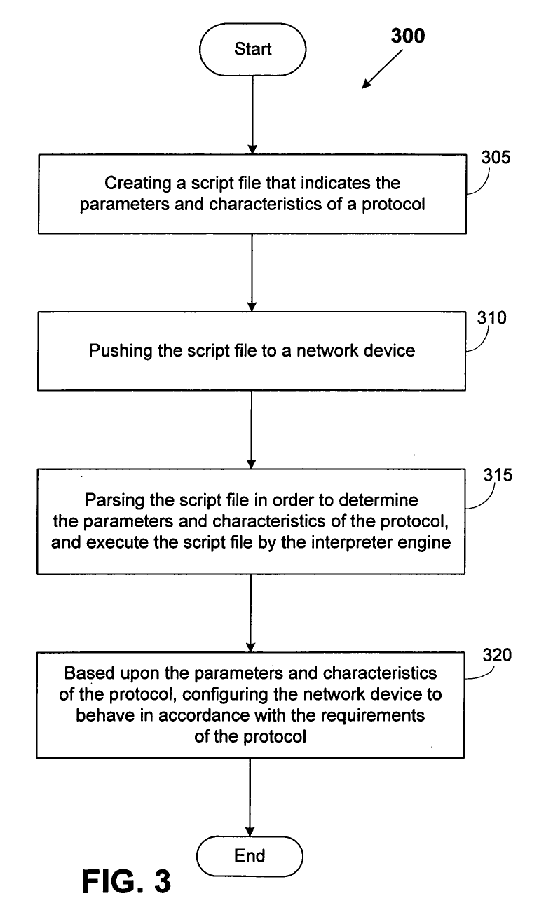

FIG. 3 is a method 300 in accordance with an embodiment of the invention. A script file is first created (305), where the script file indicates the parameters and characteristics of a protocol. The script file is pushed (310) to the network device. The script file is parsed (315) by the interpreter engine, in order to determine the parameters and characteristics of the protocol, and the script file is also executed (315) by the interpreter engine.

Based upon the parameters and characteristics of the protocol, the network device is configured (320) to behave in accordance with the requirements of the protocol.

Therefore, an embodiment of the invention provides an interpreter engine 160 in a network device, so that the network device 115 can understand various protocols 110, such as, for example, various discovery protocols. A protocol 110 is understood by the network device 115 by sending a script file 120 to the network device 115. The script file 120 includes various characteristics and parameters of the protocol 110. For example, the script file 120 would permit the interpreter engine 160 to learn about various parameters for the protocol 110 such as, e.g., ports to listen to, input signals, output signals, packet description, and/or other parameters or characteristics.

Various elements in the drawings may be implemented in hardware, software, firmware, or a combination thereof.

The various engines, applications, or software discussed herein may be, for example, computer software, firmware, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of an embodiment of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

It is also noted that the various functions, variables, or other parameters shown in the drawings and discussed in the text have been given particular names for purposes of identification. However, the function names, variable names, or other parameter names are only provided as some possible examples to identify the functions, variables, or other parameters. Other function names, variable names, or parameter names may be used to identify the functions, variables, or parameters shown in the drawings and discussed in the text.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for permitting interpretation of a protocol in a network, the apparatus comprising:
a network device including an interpreter engine configured to receive a script file and interpret a protocol based upon the script file; and
a processor configured to execute the interpreter engine.

2. The apparatus of claim 1, wherein the network device generates a behavior by the network device in accordance with the protocol, in response to the interpretation of the script file by the network device.

3. The apparatus of claim 1, wherein the network device is a network switch.

4. The apparatus of claim 1, wherein the script file is pushed to the network device.

5. The apparatus of claim 1, wherein the script file indicates parameters and characteristics of the protocol.

6. The apparatus of claim 1, wherein the script file is in an Extensible Markup Language (XML) format.

7. The apparatus of claim 1, wherein the protocol is a language that is used for communication between devices in the network.

8. The apparatus of claim 1, wherein the protocol is a device discovery protocol.

9. The apparatus of claim 1, wherein the protocol is a voice-over-internet-protocol.

10. The apparatus of claim 1, wherein the protocol is a wireless communication protocol.

11. The apparatus of claim 1, wherein the script file is executed by the interpreter engine.

12. A method for permitting interpretation of a protocol in a network, the method comprising:
receiving a script file by a network device; and
interpreting a protocol based upon the script file.

13. The method of claim 12, further comprising:
in response to the act of interpreting the protocol, generating a behavior by the network device in accordance with the protocol.

14. The method of claim 12, wherein the network device is a network switch.

15. The method of claim 12, wherein the script file is pushed to the network device.

16. The method of claim 12, wherein the script file indicates parameters and characteristics of the protocol.

17. The method of claim 12, wherein the script file is in an Extensible Markup Language (XML) format.

18. The method of claim 12, wherein the protocol is a language that is used for communication between devices in the network.

19. The method of claim 12, wherein the protocol is a device discovery protocol.

20. The method of claim 12, wherein the protocol is a voice-over-internet-protocol.

21. The method of claim 12, wherein the protocol is a wireless communication protocol.

22. The method of claim 12, wherein the script file is executed by the interpreter engine.

23. An apparatus for permitting interpretation of a protocol in a network, the apparatus comprising:
means for receiving a script file by a network device; and
coupled to the receiving means, means for interpreting a protocol based upon the script file.

24. An article of manufacture comprising:
a machine-readable medium having stored thereon instructions to:
receive a script file by a network device; and
interpret a protocol based upon the script file.
